(19) United States
(12) Patent Application Publication
(10) Pub. No.: US 2025/0303635 A1
(43) Pub. Date: Oct. 2, 2025

(54) 3D PRINTING DEVICE WITH A NUMBER OR PRINT HEAD ROWS

(71) Applicant: NEW AIM3D GMBH, Rostock (DE)

(72) Inventors: Clemens Lieberwirth, Rostock (DE); Vincent Morrison, Krakow am See (DE); Robert Radon, Rostock (DE); Mathias Schmidt, Sanitz (DE); Tim Weidner, Rostock (DE); René Zielke, Rostock (DE)

(21) Appl. No.: 18/847,088

(22) PCT Filed: Mar. 7, 2023
(86) PCT No.: PCT/EP2023/055725

§ 371 Date: Sep. 13, 2024

(30) Foreign Application Priority Data
Mar. 14, 2022 (DE) 10 2022 105 853.0

(51) Int. Cl. B29C 64/182; B29C 64/209; B29C 64/245; B33Y 30/00

(52) U.S. Cl. CPC B29C 64/182; B29C 64/209; B29C 64/245; B33Y 30/00

(57) ABSTRACT

The proposed solution relates to a 3D printing device for additive manufacturing, including a plurality of print heads arranged one beside the other along a transverse axis, via which one component each can be additively manufactured. The proposed 3D printing device includes at least two rows each with a plurality of print heads arranged one beside the other along a transverse axis, which are arranged one behind the other along a longitudinal axis.

### CROSS REFERENCE TO RELATED APPLICATIONS

This application is a 35 U.S.C. § 371 National Phase Entry Application from PCT/EP2023/055725, filed Mar. 7, 2023, designating the U.S., and claims the benefit of German Application No. 10 2022 105 853.0, filed Mar. 14, 2022, the disclosures of which are incorporated herein by reference in their entireties.

### FIELD OF THE INVENTION

The proposed solution relates to a 3D printing device for additive manufacturing, which includes a plurality of print heads arranged one beside the other along a transverse axis, via which one component each can be additively manufactured.

### SUMMARY

It is already known from practice to arrange a plurality of (at least two) print heads one beside the other in a 3D printing device in order to be able to therewith additively manufacture a plurality of components at the same time. With one print head each a component then, for example, can be constructed layer by layer. Usually, identical components here are manufactured at the same time, in order to increase the number of components to be manufactured per unit time in an additive manufacturing process.

However, there still is a need of 3D printing devices with which the production of components can be flexibilized further in the additive manufacture.

This is remedied by a 3D printing device of claim 1.

There is proposed a 3D printing device which includes at least two rows each with a plurality of print heads arranged one beside the other along a transverse axis, which are arranged one behind the other along a longitudinal axis.

The idea underlying the proposed solution thus is to provide a 2D matrix of print heads, via which not only a larger number of possibly identical components can be additively manufactured, but with which the process parameters also can be adapted more easily during the manufacture of a plurality of components via an individual 3D printing device.

In principle, the proposed 3D printing device for a construction of the components layer by layer can comprise at least one extruder for one print head each or one subgroup of print heads each or a plurality of extruders, at least one processor for controlling the at least one extruder and at least one memory for storing control commands for controlling the extruder. The processor and memory here can be integrated in an electronic control unit via which the position of the print heads can also be controlled.

In one design variant, the 3D printing device includes at least one crossbeam for at least one row of push buttons, on which the print heads can be positioned at different transverse distances to each other. Hence, there is provided a crossbeam on which at least two print heads are arranged at a distance adjustable relative to each other. The print heads of one row, for example, can be shiftably mounted on the associated crossbeam. Depending on the component to be manufactured, the print heads thus can be positioned differently along the crossbeam and hence along the transverse axis defined with the crossbeam.

To further simplify the positioning of the print heads on a crossbeam, one design variant provides a power-operated adjustability of the transverse distances of the print heads of one row. Consequently, the positions of the print heads on the crossbeam and the resulting transverse distances between the push buttons here can be adjusted in an electronically controlled way. For this purpose, a motorized transverse adjusting device, for example, can be part of the 3D printing device. Via such a transverse adjusting device different transverse distances of the print heads of one row relative to each other then, for example, can be adjusted in a motor-driven way.

For example, the transverse adjusting device therefor includes at least one spindle drive. On a spindle of such a spindle drive a spindle nut meshing with the spindle and connected to one of the print heads then, for example, can be provided so that by a rotation of the spindle a position of the respective print head along the spindle axis extending in parallel to the transverse axis can be adjusted.

In one design variant, the 3D printing device includes a plurality of (at least two) crossbeams whose longitudinal distance to each other can be adjusted along the longitudinal axis. Consequently, in such a design variant, not only the distances of the print heads within a row are variable relative to each other along the transverse axis, but also the distances of the print heads along the longitudinal axis. The at least two crossbeams can be adjusted relative to each other so as to position the rows of print heads carried by the same in groups with different longitudinal distances to each other. In addition, the print heads also can be spaced apart from each other on their respective crossbeam with different transverse distances to each other. Hence, the positions of the 2D matrix of push buttons can be variably adapted, in particular depending on the size of the components to be manufactured.

The plurality of crossbeams are adjustably mounted relative to each other, for example, via a longitudinal adjustment device of the 3D printing device. The longitudinal adjustment device, for example, can comprise one or more adjusting motors in order to differently space the crossbeams relative to each other. Correspondingly, the longitudinal distances of the plurality of crossbeams to each other along the longitudinal axis can be adjustable in a power-operated way and hence can be electronically controllable.

To further increase the variability of the proposed 3D printing device, in particular with regard to the question of what number of components of what size can be manufactured therewith, one design variant provides that the number of the print heads per crossbeam can be adapted. For example, this can include the fact that the print heads of one row are releasably and hence also exchangeably fixed to a crossbeam.

For example, shiftable print heads can be withdrawable from a crossbeam. Alternatively or additionally, a quick plug-in connection guided by a dowel pin and/or a magnetic attachment to the crossbeam can be provided, for example, on a print head carriage shiftably mounted along the crossbeam, on which at least one print head is mounted when necessary.

For example, the 3D printing device comprises a positioning system via which the print heads can be individually mounted on the associated crossbeam and can be removed from the associated crossbeam. To consequently vary the number of print heads on a crossbeam and hence on a row of push buttons, no manual intervention of a user is necessary on the crossbeam. Rather, a number of push buttons here is varied in a power-operated way in that via a mechanism of the positioning system—possibly by using the transverse adjustment device and/or the longitudinal adjustment device of the 3D printing device—individual print heads are removed from a crossbeam or are mounted on the crossbeam and then the print heads subsequently move into a specified position on the crossbeam.

For example, the 3D printing device can comprise a print head magazine on which a limited number of additional print heads is kept in store or into which print heads removed from a crossbeam can be introduced. Of course, there can also be provided a plurality of print head magazines for individual crossbeams or a group of crossbeams so that then print heads are kept in store in a print head magazine, which can be used on a plurality of crossbeams. Likewise, print heads of a plurality of crossbeams can be accommodated in a print head magazine when less print heads are to be provided on a crossbeam for the current additive manufacturing process.

In principle, the 3D printing device can comprise at least one print bed arranged below the print heads for at least one component to be manufactured. Here, a common print bed for several rows of push buttons and hence a common print bed for several components to be manufactured (at the same time) can be provided. Likewise, a plurality of print beds can be provided, of which one print bed each is associated to exactly one row of push buttons.

To further increase the variability—by accepting a corresponding control-related complexity—one design variant can provide that an individual print bed is associated to each print head. Thus, print-head-individual print beds are provided, possibly with an individual adjustability of the print beds relative to the respectively associated print head.

In principle, a print bed of the 3D printing device, in particular a common print bed for several or individual rows of push buttons, can be adjustable along a vertical axis. Alternatively or additionally, an adjustability can be provided along the transverse axis and/or along the longitudinal axis with respect to the print heads. An adjustability of the respective print bed along the vertical axis, along the transverse axis and/or along the longitudinal axis here can be usable both for positioning the print bed relative to an individual print head or a plurality of print heads before the beginning of an additive manufacturing process. Of course, however, it is also conceivable that the respective adjustability provides for an adjustment of the print bed during an additive manufacturing process. In particular the adjustment along a vertical axis regularly serves to adjust the print bed during the layer-by-layer construction of the component to be additively manufactured, while the print head remains in a fixed (vertical) position within the 3D printing device.

In principle, at least one of the print heads alternatively or additionally can be adjustable on its crossbeam with respect to the associated print bed during an additive manufacture. In such a design variant, the respective print head consequently can be prepositioned on a crossbeam at a particular transverse distance to the other print head not only before a start of the additive manufacture. Rather, the at least one print head then can be adjustable also during an additive manufacturing process, in particular along a vertical axis and/or along the transverse axis and/or along the longitudinal axis. For example, the crossbeam can be adjustable completely along the vertical axis in order to be able to vary a distance of the crossbeam to a print bed.

In one design variant, the 3D printing device comprises an electronic control unit via which transverse distances of print heads of a row relative to each other along the (respective) transverse axis and/or longitudinal distances of the rows of print heads relative to each other along the longitudinal axis can be specified in a power-operated way. Via the electronic control unit at least one adjusting motor of a transverse adjustment device and/or of a longitudinal adjustment device then consequently can be actuated in order to correspondingly position the print heads.

Via a corresponding electronic control unit the number of print heads of a row can also be specifiable in a power-operated way. For example, a positioning system of the 3D printing device as explained above therefor is actuated via the electronic control unit.

To facilitate the handling of the 3D printing device, the electronic control unit coupled with the positioning system can be adapted to automatically adjust positions of the print heads of a row along the (respective) transverse axis and/or positions of the rows along the longitudinal axis in a power-operated way in dependence on dimensions of a component to be manufactured specified via a user interface. The electronic control unit consequently is adapted to automatically derive in a processor-assisted way, on the basis of component parameters provided on a user interface, what number of push buttons is used for a simultaneous multiple manufacture of the respective component and how the individual print heads here must be positioned relative to each other along the transverse axis and along the longitudinal axis. For example, via the user interface a user merely can read in data on a generated model of the component to be manufactured. Instructions of a calculation algorithm stored in the electronic control unit for execution by at least one processor of the electronic control unit then in an automated way—in response to a command of the user—specify the positions of the 2D matrix of push buttons on the 3D printing device and correspondingly adjust the 2D print head matrix. Of course, however, it can also be possible alternatively or additionally for a user to directly enter the dimensions of the component to be manufactured multiple times via the user interface.

The attached FIGURE by way of example illustrates possible design variants of the proposed solution.

### BRIEF DESCRIPTION OF THE DRAWINGS

In the drawing:

FIG. 1 in a perspective view and sectionally shows a design variant of a proposed 3D printing device, in which there is provided a plurality of print heads adjustable along two directions in space perpendicular to each other, which can be variably positioned with regard to their transverse distances and longitudinal distances to each other.

### DETAILED DESCRIPTION

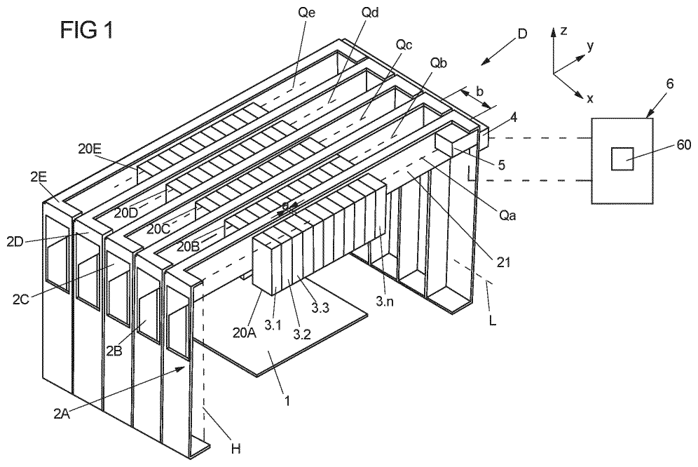

FIG. 1 shows a design variant of a proposed 3D printing device D, in which above a printing platform or a print bed 1 several rows 20A to 20E of push buttons 3.1, 3.2, 3.3 to 3.n are arranged one behind the other. Parts of the 3D printing device D, which is provided for the additive manufacture of a plurality of components via the print heads 3.1, . . . , 3.n, also include an extruder device not shown in FIG. 1. This extruder device includes at least one extruder for supplying the print heads 3.1, . . . , 3.n with printing material.

Each row 20A to 20E includes a plurality of print heads 3.1, . . . , 3.n which are arranged one beside the other along a transverse axis Qa to Qe extending perpendicularly to the longitudinal axis L. The 3D printing device D thus includes a 2D matrix of push buttons 3.1, . . . , 3.n in an xy-plane. Identical components thereby can be additively constructed at the same time in parallel layer by layer. Via a corresponding actuation of the print heads 3.1, . . . , 3.n and a possibly separate print bed, however, components of different geometric configuration also can be manufactured at the same time.

In the illustrated 3D printing device D, the print heads 3.1, . . . , 3.n of a row 20A to 20E each are held on a respective crossbeam 21 above the print bed 1 along the associated transverse axis Qa to Qe. This crossbeam 21 each is fixed to a carrier part 2A to 2E for a row 20A to 20E. The individual carrier parts 2A to 2E and hence the respective crossbeams 21 here are shiftably held along the longitudinal axis L in order to be able to variably adjust a longitudinal distance b between individual rows 20A to 20E on push buttons 3.1, . . . , 3.n.

Furthermore, the individual print heads 3.1, . . . , 3.n of a row 20A to 20E each can be positioned relative to each other with different transverse distances a on the respective crossbeam 21. In this way, the print heads 3.1, . . . , 3.n can be positioned relative to each other at desired distances both along a transverse direction y and along a longitudinal direction x. The positions of the push buttons 3.1, . . . 3.n can be specified in a power-operated way by means of an electronic control unit 6 of the 3D printing device both along their respective transverse axis Qa to Qe and along the longitudinal axis L (in the latter case row by row).

Via the electronic control unit 6 both a longitudinal adjustment device 4 and a transverse adjustment device 5 of the 3D printing device D can be controlled. The longitudinal adjustment device 4 and the transverse adjustment device 5 include at least one adjusting motor, possibly also a plurality of adjusting motors for the individual rows 20A to 20E. In response to electronic control signals of the electronic control unit 6, the carrier parts 2A to 2E and consequently the crossbeams 21 can be longitudinally spaced apart from each other as specified, and furthermore the print heads 3.1, . . . , 3.n on a crossbeam 21 can each correspondingly be transversely spaced apart from each other as specified within a respective row 20A to 20E.

A user interface 60 can be part of the electronic control unit 6, via which dimensions for the components to be manufactured can be specified. The electronic control unit 6 then determines the positions to be specified for the push buttons 3.1, . . . , 3.n for the respective specified dimensions within the 3D printing device. The electronic control unit 6 therefor correspondingly actuates a positioning system of the 3D printing device D comprising the longitudinal adjustment device 4 and the transverse adjustment device 5 with reference to a stored algorithm.

Via the positioning system, in one design variant, a power-operated removal and addition of push buttons 3.1, . . . , 3.n electronically controlled via the electronic control unit 6 becomes possible at one or more crossbeams 21 of the different carrier parts 2A to 2E. For example, a corresponding (print head) magazine of push buttons of the 3D printing device D can be equipped with push buttons withdrawn from a crossbeam 1. Conversely, print heads to be used in addition can also be removed from such a (print head) magazine and crossbeams 21 of the carrier parts 2A to 2E can be automatically equipped therewith. The print heads 3.1, . . . , 3.n therefor can be shiftable, for example, on crossbeams 21 individually via one carriage each and—on coupling of the carriages with each other—also row by row. Shiftably mounting a print head 3.1, . . . , 3.n on a respective crossbeam 21 need not exclusively serve the prepositioning of a print head 3.1, . . . , 3.n before an additive manufacturing process. Rather, a respective print head 3.1, . . . , 3.n also can be shiftable along the crossbeam 21 for the additive manufacture.

To construct a plurality of components layer by layer via the print heads 3.1, . . . , 3.n, the crossbeams 21 can be adjustable (electronically controlled via the electronic control unit 6) with respect to the print bed 1 on their respective carrier part 2A to 2E along a vertical axis H. This vertical axis H extends perpendicularly to the xy-plane in which the print heads 3.1, . . . , 3.n can be variably spaced apart from each other.

Alternatively or additionally, the print bed 1 or a plurality of different print beds, which are associated to individual push buttons 3.1, . . . , 3.n or individual rows 20A to 20E of the 3D printing device, can be adjustable along the vertical axis H.

### LIST OF REFERENCE NUMERALS

1 printing platform/print bed
20A-20E row
21 crossbeam
2A-2E carrier part
3.1, 3.2, 3.3, 3.n print head
4 longitudinal adjustment device
transverse adjustment device
6 electronic control unit
60 user interface
a transverse distance
b longitudinal distance
D 3D printing device
H vertical axis
L longitudinal axis
Qa-Qe transverse axis

1-20. (canceled)

21. A 3D printing device for additive manufacturing, the device comprising:
a plurality of print heads arranged one beside each other along a transverse axis, via each of which a component can be additively manufactured, wherein the 3D printing device includes a plurality of rows, each row including a plurality of print heads arranged one beside the other along a transverse axis, wherein the plurality of rows are arranged one behind the other along a longitudinal axis.

22. The 3D printing device according to claim 21, further comprising at least one crossbeam for supporting at least one row of print heads, on which the print heads of the at least one row of print heads are positioned at different transverse distances to each other.

23. The 3D printing device according to claim 22, wherein the print heads of a row of the at least one row of print heads are shiftably mounted on an associated crossbeam of the at least one crossbeam.

24. The 3D printing device according to claim 22, wherein the transverse distances of the print heads of a row are adjustable in a power-operated way on an associated crossbeam of the at least one crossbeam.

25. The 3D printing device according to claim 22, further comprising a plurality of crossbeams whose longitudinal distance to each other are adjustable along the longitudinal axis.

26. The 3D printing device according to claim 25, further comprising a longitudinal adjustment device including one or more motors, wherein the plurality of crossbeams are adjustably mounted relative to each other on the longitudinal adjustment device.

27. The 3D printing device according to claim 25, wherein the longitudinal distances of the plurality of crossbeams to each other are adjustable in a power-operated way along the longitudinal axis.

28. The 3D printing device according to claim 22, wherein the at least one crossbeam adapted for including a variable number of the print heads.

29. The 3D printing device according to claim 28, further comprising a positioning system configured for individually mounted the print heads on an associated crossbeam of the at least one crossbeam and for removing from print heads from the associated crossbeam.

30. The 3D printing device according to claim 21, further comprising at least one print bed arranged below the print heads for supporting at least one component to be manufactured.

31. The 3D printing device according to claim 30, wherein a common print bed of the at least one print bed is associated with a plurality of rows of print heads for manufacturing several different components.

32. The 3D printing device according to claim 31, wherein the common print bed is adjustable with respect to the print heads along a vertical axis and/or along the transverse axis and/or along the longitudinal axis.

33. The 3D printing device according to claim 30, wherein exactly one print bed is associated with exactly one row of print heads for manufacturing several different components.

34. The 3D printing device according to claim 33, wherein the exactly one print bed is adjustable with respect to the print heads of the row along a vertical axis and/or along the transverse axis and/or along the longitudinal axis.

35. The 3D printing device according to claim 30, wherein exactly one print bed is associated with exactly one row of print heads for manufacturing exactly one component.

36. The 3D printing device according to claim 30, further comprising at least one crossbeam for supporting at least one row of print heads, on which the print heads of the at least one row of print heads are positioned at different transverse distances to each other, wherein at least one of the print heads are adjustable on the at least one crossbeam with respect to an associated print bed of the at least one print bed during an additive manufacture.

37. The 3D printing device according to claim 30, further comprising at least one crossbeam for supporting at least one row of print heads, on which the print heads of the at least one row of print heads are positioned at different transverse distances to each other, wherein at least one crossbeam can be adjusted with respect to an associated print bed of the at least one print bed during an additive manufacture.

38. The 3D printing device according to claim 21, further comprising an electronic control unit configured for specifying transverse distances of print heads of a row to each other along the transverse axis and/or longitudinal distances of the rows to each other along the longitudinal axis a power-operated way.

39. The 3D printing device according to claim 38, wherein the electronic control unit is configured for specifying a number of the print heads of a row in a power-operated way.

40. The 3D printing device according to claim 38, wherein the electronic control unit is coupled with a positioning system of the 3D printing device and is adapted to automatically adjust, in a power-operated way, positions of the print heads of a row along the transverse axis and/or positions of the rows along the longitudinal axis in dependence on dimensions of a component to be manufactured specified via a user interface.
